(19) United States
(12) Patent Application Publication
(10) Pub. No.: US 2024/0047951 A1
(43) Pub. Date: Feb. 8, 2024

(54) APPARATUS FOR DISTRIBUTING SUPPLY OF POWER TO LOADS

(71) Applicant: NEXT PRIVATE LIMITED, Gujarat (IN)

(72) Inventors: Ashutosh Gupta, Gujarat (IN); Harsh Bhikadia, Gujarat (IN); Vishal Pratik, Gujarat (IN); Praveen Khichar, Rajasthan (IN)

(21) Appl. No.: 18/251,463

(22) PCT Filed: Sep. 20, 2021
(86) PCT No.: PCT/IB2021/058541

§ 371 Date: May 2, 2023

(30) Foreign Application Priority Data
Nov. 3, 2020 (IN) 202021047871

(51) Int. Cl. H02B 1/015; H02B 1/20; H01R 13/703

(52) U.S. Cl. CPC H02B 1/015; H02B 1/20; H01R 13/7038

(57) ABSTRACT

The present disclosure relates to an apparatus (100) for distributing supply of power to one or more loads, the apparatus includes a switchboard (102) that includes one or more first connectors (106), configured to supply power to corresponding one or more loads, and configured to receive an input power supply, one or more smart-devices (104) associated with corresponding one or more loads, and electrically couple with corresponding one or more first connectors. A processor (114) configured to receive, the input pertaining to parameters of power to be supplied to the associated load, and operate a regulator to supply power to the corresponding coupled first connector according to the received parameters, wherein the power supplied to the corresponding coupled first connector is transmitted to the associated load to operate the associated load.

### TECHNICAL FIELD

The present disclosure relates, in general, to electrical distribution systems, and more specifically, relates to an apparatus for distributing supply of power to one or more loads.

### BACKGROUND

The electricity control apparatuses such as but not limited to electrical sockets, electrical wall switchboards, electrical switches, control the electrical appliances in residential as well as commercial properties. In conventional residential and commercial construction, outlets for electricity and telephone lines are installed in the walls of a room, open space, fixed spaced locations around the room and the like. Installation of the electrical apparatuses is difficult, and/or costly and/or requires professional labour.

Based on known or initial anticipated needs of the electrical appliances in the residential or commercial properties, these electrical apparatuses are fixed and remains immutable for minor or major changes, whereas the anticipated needs of consumers change over the time. Any small change and/or repair and/or design and/or technology upgrade requires rewiring which is difficult and/or under unsupervised conditions, even harmful. Also, the limitation of the conventional electricity control apparatuses are as follows:
Electrical apparatuses are fixed and immutable for further upgrades in the future in terms of, but not limited to, design, aesthetics, technology as well as functionality, until the user rewires the complete existing electrical apparatus.
Repairing and/or upgrading the existing electrical apparatuses is difficult and/or costly and/or harmful under unsupervised conditions, e.g., risks of getting electrocuted.
Users cannot control the electrical apparatuses with Internet technologies which brings inconvenience and/or discomfort to user's life even though having smartphone and/or voice assistant at his/her disbursal.
Existing electrical apparatuses cannot provide individual appliance (also interchangeably referred to as load) level electrical energy usage data.
Users who are utilizing existing electrical apparatuses may experience electrical shocks due to switch-bouncing phenomenon.
Users cannot pre-schedule and/or create countdown and/or create timetable for the electrical and/or electronic appliances connected to the existing electrical apparatus, in order to control the supply of electricity to other electric and/or electronic appliances based on the requirement of the user.
Users cannot automatically control the supply of electricity to the electrical or electronic devices based on the heat and/or movement of objects

Therefore, there is a need in the art to provide a means that can distribute supply of power to one or more loads by solving the aforementioned problems.

### Objects of the Present Disclosure

An object of the present disclosure relates, in general, to electrical distribution systems, and more specifically, relates to an apparatus for distributing supply of power to one or more loads.

Another object of the present disclosure is to provide an apparatus that can be upgraded easily as the user can hot-swap or mount/de-mount the one or more smart-devices based on their individual desires and/or requirements, without re-wiring the complete electrical apparatuses.

Another object of the present disclosure is to provide an apparatus that can be controlled programmatically using wireless communications, and/or can be controlled manually using in-built switch.

Another object of the present disclosure is to provide an apparatus that can record the electrical energy usage data of an individual and/or group of appliances connected to the one or more smart-devices.

Another object of the present disclosure is to provide an apparatus and/or smart-devices that can use low voltage direct current to control the supply of electricity to turn on/off and/or dim the appliances, which can drastically reduce the likelihood of getting electrical shocks caused due to switch bouncing phenomenon

Another object of the present disclosure is to provide an apparatus that can allow the users to pre-schedule and/or create countdown and/or create timetable for the electrical and/or electronic appliances connected to the electrical apparatus, to control the supply of electricity to other electric and/or electronic appliances based on the requirement of the user.

Another object of the present disclosure is to provide an apparatus that can detect the heat and/or movement of an object in the environment to allow user to pre-program and/or schedule to real-time control the supply of electricity to the electrical and/or electronic devices connected to the electrical apparatus.

Another object of the present disclosure is to provide an apparatus that can be repaired and/or upgraded easily and can be cost-effective.

Yet another object of the present disclosure is to provide an apparatus that can safeguard the user's appliances from the electrical damage and/or safeguard the switchboard from unwanted electrical damages.

### SUMMARY

The present disclosure relates, in general, to electrical distribution systems, and more specifically, relates to an apparatus for distributing supply of power to one or more loads.

In an aspect, the present disclosure provides an apparatus for distributing supply of power to one or more loads, the apparatus including: a switchboard comprising one or more first connectors, the one or more first connectors configured to supply power to corresponding one or more loads, the one or more first connectors configured to receive an input power supply, one or more smart-devices associated with corresponding one or more loads, the one or more smart-devices configured to electrically couple with corresponding one or more first connectors, the one or more smart-devices configured to receive a power supply from a power source, each of the one or more smart-devices including a regulator to control the supply power to a corresponding coupled one or more first connector, a receiver configured to receive input signals pertaining to parameters of power to be supplied to an associated load of the one or more loads, the parameters pertaining to any or a combination of voltage, frequency, time and pulse width modulation of the power, and a processor operatively coupled with the switchboard and the one or more smart-devices, the processor operatively coupled with a memory, the memory storing instructions executable by the processor to receive, the input signals pertaining to parameters of power to be supplied to the associated load, and operate the regulator to control the supply power to the corresponding coupled one or more first connector according to the received parameters, wherein the power supplied to the corresponding coupled one or more first connector is transmitted to the associated load to operate the associated load.

In an embodiment, the one or more smart-devices can be associated with a combination of zero loads.

In another embodiment, the one or more smart-devices can include switch, light dimmer, fan regulator, microphone, speaker, camera, infrared emitter, infrared receiver, motion detector, thermal detectors and any combination thereof, wherein the one or more smart-devices and the switchboard are of variable size and shapes.

In another embodiment, the one or more smart-devices may include one or more second connectors configured to electrically couple with corresponding one or more first connectors, the first connectors and the second connectors may include any or a combination of male pins and female pins to carry any or a combination of alternating current (AC) power, direct current (DC) power and data between the one or more smart-devices and the switchboard.

In another embodiment, the communication between the switchboard and the one or more smart-devices can be performed by any or a combination of wired mode, wireless communication mode and coupled connectors.

In another embodiment, the one or more smart-devices can be configured to store and supply power received from the switchboard, the power received can be any or a combination of AC and DC.

In another embodiment, one or more light emitting diodes (LEDs) can be configured in the one or more smart-devices, the one or more LEDs adapted to change colours based on any or a combination in build functions and information received from user.

In another embodiment, the processor can be operatively coupled to a learning engine, the learning engine can be trained using a historical data of correlation received from the one or more smart-devices, wherein the switchboard can determine behavioural patterns of the corresponding one or more loads associated with the one or more smart-devices.

In another embodiment, the one or more smart-devices can be replaceable with another one or more smart-devices having any or a combination of similar and different functions in the switchboard without rewiring.

In another embodiment, the switchboard can be configured to detect any or a combination of the position of the one or more smart-devices, digital signature and type of one or more smart-devices.

In another embodiment, the one or more smart-devices can be configured to record the current usage of the corresponding one or more loads connected to the one or more smart-devices through one or more first connectors.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWINGS

The following drawings form part of the present specification and are included to further illustrate aspects of the present disclosure. The disclosure may be better understood by reference to the drawings in combination with the detailed description of the specific embodiments presented herein.

FIGS. 1A-1E illustrate exemplary representation of an apparatus for distributing supply of power to one or more loads, in accordance with an embodiment of the present disclosure.

FIGS. 2A-2D illustrate exemplary representation of one or more first connectors mounted on top portion of switchboard, in accordance with an embodiment of the present disclosure.

FIGS. 3A-3F illustrate exemplary view of the variable configuration of one or more smart-devices, in accordance with an embodiment of the present disclosure

FIGS. 4A-4D illustrate exemplary view of apparatus of variable size, in accordance with an embodiment of the present disclosure.

### DETAILED DESCRIPTION

The following is a detailed description of embodiments of the disclosure depicted in the accompanying drawings. The embodiments are in such detail as to clearly communicate the disclosure. If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The present disclosure relates, in general, to electrical distribution systems, and more specifically, relates to an apparatus for distributing supply of power to one or more loads. The apparatus can allow users to swap, replace, upgrade, clip-on smart-devices in switchboard (also referred to as multifunctional electrical wall switchboards) without having to rewire electrical wires. The present disclosure can be described in enabling detail in the following examples, which may represent more than one embodiment of the present disclosure.

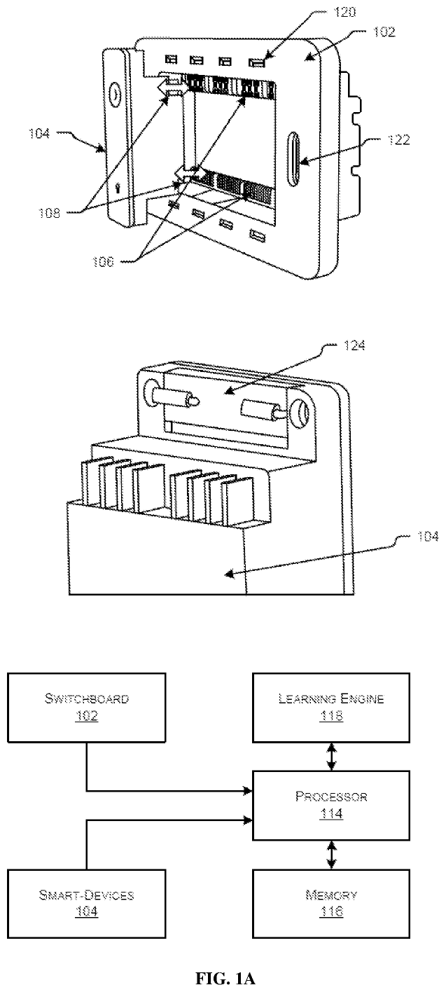

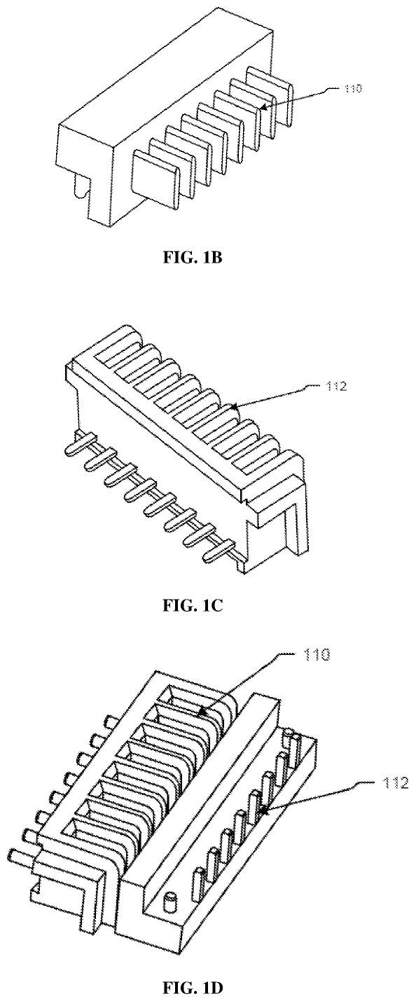

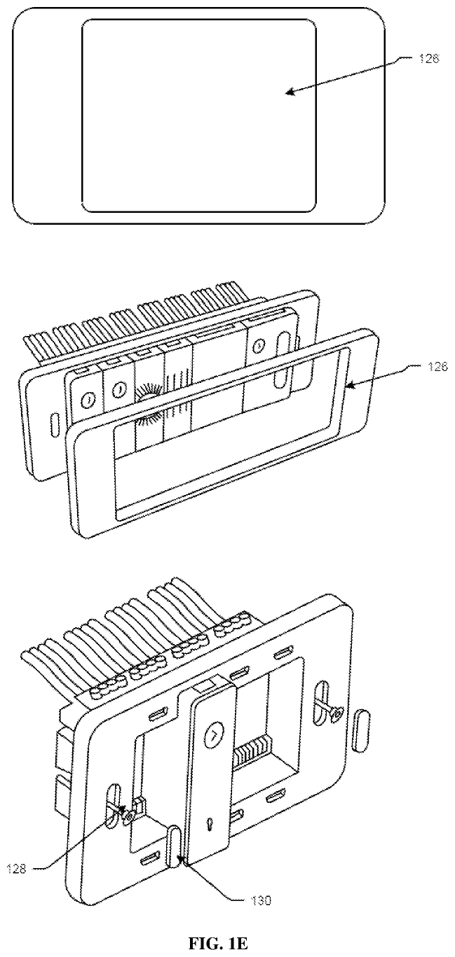

FIGS. 1A-1E illustrate exemplary representation of an apparatus for controlling the distribution of electrical energy, in accordance with an embodiment of the present disclosure.

Referring to FIG. 1A, apparatus 100 (also referred to as an electrical control apparatus 100, herein) can be configured to switch, and vary the supply of electricity to one or more loads, the one or more loads can be interchangeably referred to as electrical and/or electronic appliances, the apparatus 100 can also provide electrical energy to power up other electronic devices through universal serial bus (USB) or other equivalent power providing apparatuses. The apparatus 100 may include a switchboard 102 also interchangeable referred to as a baseboard 102, and one or more smart-devices 104 also interchangeable referred to as mountable and demountable modules 104.

The apparatus 100 as mentioned in the present disclosure can be implemented to the existing electrical wall switchboards that can control the supply of electricity to connected peripheral electrical appliances through a combination of electrical wiring and controlling through one or more smart-devices 104 such as smart switches, smart sockets, smart dimmers (fan and/or light), motion sensor, occupancy sensor, USB ports, speaker and/or microphone, infrared receiver and/or emitter, smart camera, combination of RBG light emitting diode (LED)night lights, display touch screen and any combination thereof.

In an embodiment, the switchboard 102 may include one or more first connectors 106, and the one or more smart-devices 104 may include one or more second connectors 108 configured to electrically couple with corresponding one or more first connectors 106. The one or more first connectors 106 and the one or more second connectors 108 may include any or a combination of male pins 110 and/or female pins 112 as illustrated in FIG. 1B and FIG. 1C respectively, these male and female pins (110, 112) can carry any or a combination of alternating current (AC), direct current (DC) and data. In an exemplary embodiment, the AC carrying pins (male pin and/or female pin) can be located on top portion of the switchboard 102 and the one or more smart-devices 104, the AC carrying pins can control the supply of electrical energy to the one or more smart-devices 104 from the switchboard 102. The DC carrying pins (male pin and/or female pin) can be located on bottom portion of the switchboard 102 and the one or more smart-devices 104, the DC carrying pins can exchange data such as information, commands, status, actions and supply DC electric charge between the one or more smart-devices 104 and the switchboard 102, however, the present disclosure is not limited to this configuration but may be applied to other configurations.

In another embodiment, the one or more first connectors 106 in the switchboard 102 may include varied number of male pins 110 and/or female pins 112, wherein one set of connector pins can be configured to carry electrical AC energy and the other set of connector pins can be configured to carry DC energy and data. Similarly, the one or more second connectors 108 in the one or more smart-devices 104 may include varied number of male pins 110 and/or female pins 112, wherein one set of connector pins can be configured to carry electrical AC energy and the other set of connector pins can be configured to carry DC energy and data.

In another embodiment, the one or more smart-devices 104 and the switchboard 102 can be intertwined, connected, inserted and kept into their position using three connectors, the three connectors may include mating of AC current carrying pins (male pin 110 and/or female pin 112), mating of DC current carrying pins (male pin 110 and/or female pin 112) and a set of plastic, metal or similar material connectors (120, 124). The plastic, metal or similar material connectors (120, 124) as illustrated in FIG. 1A carry no other function except locking the one or more smart-devices 104 into the switchboard 102 for a tight-snug-fit, the one or more smart-devices 104 can be locked by pushing the plastic, metal or similar material connectors and inserting them into the switchboard 102, which then releases and locks themselves, similar to snap fit locking mechanism. Screw hole positions 122 can be configured in the switchboard 102 to mount the switchboard 102 on the wall or inside the wall.

In an embodiment, the baseboard 102 may include one or more first connectors 106 configured to connect with electrical wiring within electrical junction box/electrical flush box either inside or on wall. The baseboard 102 may include one or more first connectors 106 on front portion of the base-board 102, configured to provide a cavity allowing the insertion and removal of the one or more smart-devices 104 through the one or more second connectors 108. The switchboard 102 may further include a processor, learning engine 118, receiver and the like, and the one or more smart-devices 104 may include a regulator, a processor, a receiver and the like. The communication between the switchboard 102 and the one or more smart-devices 104 can be performed by any or a combination of wired mode, wireless communication mode and coupled connectors (106, 108).

In an implementation, the switchboard 102 may include one or more first connectors 106, the one or more first connectors 106 can be configured to supply power to corresponding one or more loads, the one or more first connectors 106 can be configured to receive an input power supply. The one or more smart-devices 104 associated with the corresponding one or more loads, the one or more smart-devices 104 can also be associated with a combination of zero loads. The one or more smart-devices 104 configured to electrically couple with corresponding one or more first connectors 106 through the one or more second connectors 108, the one or more smart-devices 104 configured to receive power supply from a power source.

Each of the one or more smart-devices 104 may include regulator operable to control the supply power to a corresponding coupled one or more first connectors 106. The one or more smart-devices 104 may include receiver configured to receive input signals pertaining to parameters of power to be supplied to an associated load of the one or more loads, the parameters pertaining to any or a combination of voltage, frequency, time and pulse width modulation of the power, the processor 114 operatively coupled with the switchboard 102 and the one or more smart-devices 104, the processor 114 can be operatively coupled with a memory 116, the memory storing instructions executable by the processor 114 to receive, the input pertaining to parameters of power to be supplied to the associated load, operate the regulator to control the supply power to the corresponding coupled one or more first connector 106 according to the received parameters, wherein the power supplied to the corresponding coupled one or more first connector 106 can be transmitted to the associated load to operate the associated load.

For example, in residential and commercial buildings, the user can connect one or more electrical appliances by adding one or more smart-devices 104, where the connection can be made between the appliance output wire and the one or more first connectors 106 on the switchboard 102. The user can control the speed of the fan or can turn on/off the switch through wireless mode, manually or by any suitable means, the switchboard 102 and the one or more smart-devices 104 can receive the input signals from the user. If the user wants to control the speed of the fan through wireless mode, the processor 114 in the switchboard 102 can receive the command i.e., input signals pertaining to parameters of power to be supplied to the associated appliances from the user, the processor can forward the command to the one or more smart-devices 104, the processor in the one or more smart-devices can receive the command from the switchboard 102 using the DC carrying pins, and can further operate the regulator to control the supply of power of the associated electrical appliances using the AC carrying pins.

In another embodiment, the processor 114 can be operatively coupled with the switchboard 102 and the one or more smart-devices 104, the processor 114 can be in communication with each of the memory 116, and other components such as regulator, receiver and the like. The processor 114 may include a microprocessor or other devices capable of being programmed or configured to perform computations and instruction processing in accordance with the disclosure.

In another embodiment, the processor 114 can further be coupled to the learning engine 118, the learning engine 118 in the switchboard 102 can be configured to extract the behavioural patterns of individual/user usage of one or more loads associated with the one or more smart-devices 104. The one or more smart-devices 104 can provide the historical data report of the associated one or more loads to the switchboard 102, the learning engine 118 in the switchboard 102 can extract the historical data report received from the one or more smart-devices 104 using the DC carrying pins, the switchboard 102 can learn the report from the one or more smart-devices 104 to determine the behavioural patterns of one or more loads utilized by the user.

In another embodiment, the male pin 110 connected to either switchboard 102 or the one or more smart-devices 104 as illustrated in FIG. 1B, the female pin 112 connected to either the switchboard 102 or the one or more smart-devices 104 is illustrated in FIG. 1C. The electrical contact as shown in FIG. 1D illustrates the mating of the male pin 110 and the female pin 112 with each other, connected to either switchboard 102 and the one or more smart-devices 104 or vice versa, these electrical contacts can exchange computational and/or command execution data and/or DC energy between the switchboard 102 and the one or more smart-devices 104.

In another embodiment, the baseboard 102 may include at least one variable sized AC to DC converter minimum capacity of 0.5 A or more that can allow the baseboard 102 to consume AC electricity through the one or more first connectors 106 mounted on a printer circuit board (PCB) and then convert electrical AC energy into DC energy, the DC energy can be utilized to power-up the internal processing engine of the switchboard 102, for example, processor, receiver, learning engine 118 and the like. The same DC energy can be further supplied to the one or more smart-devices 104 using the DC carrying pins to supply DC power to the connected appliances using USB and the like. Therefore, the AC to DC converter can be used in the apparatus 100 for self-sustaining the internal processing engine of the switchboard 102 and the internal processing engine of the one or more smart-devices 104.

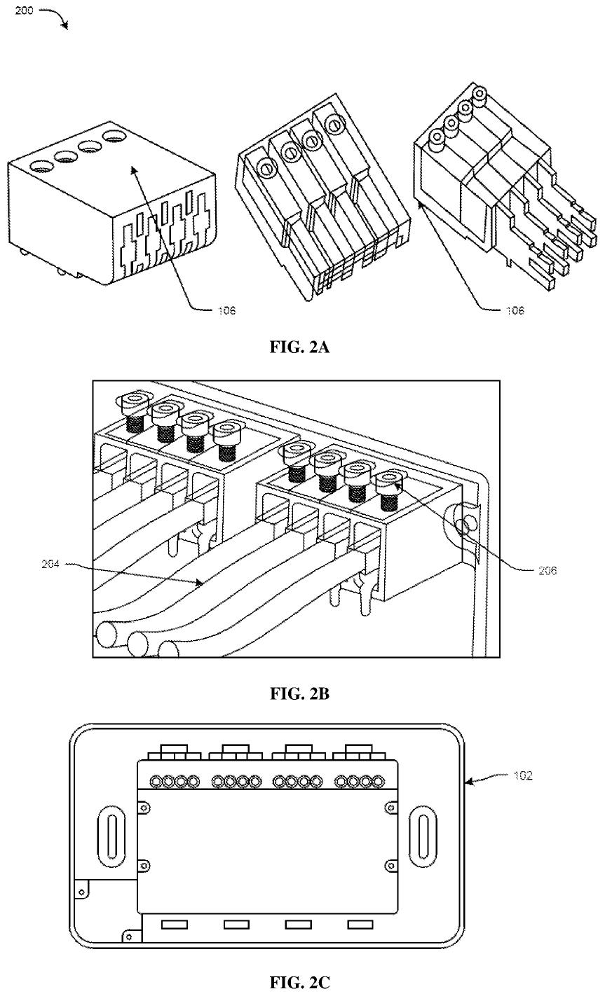

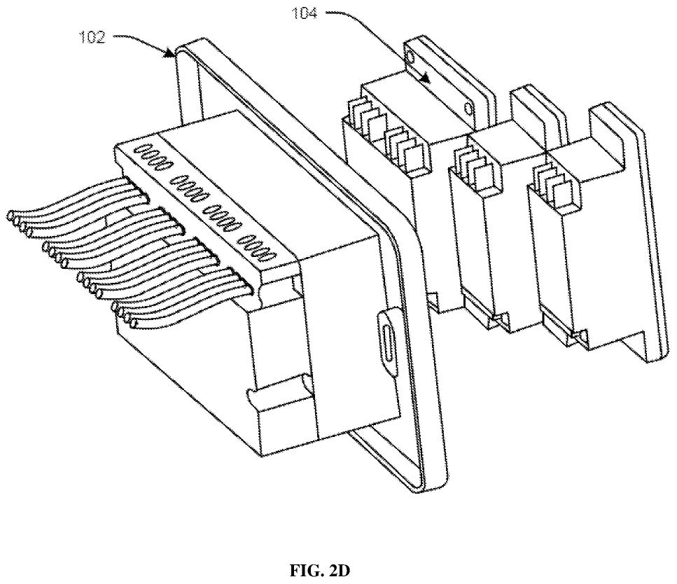

AC carrying pins in the switchboard 102 are made in such a way that the first part directly connects with electrical wiring 204 using a screw 206 as illustrated in FIG. 2B on the top to keep the wiring secure and the second part e.g., female connects with the one or more smart-devices 104. This connector may involve PCB mounting to transfer AC power through PCB to AC to DC converter and/or it can directly connect to the one or more smart-devices 104 and allow them to control the supply of the AC electrical energy to the load connected to the one or more smart-devices 104.

In another embodiment, combination of AC carrying pins and DC carrying pins in the one or more first connectors 106 of the switchboard 102 and in the one or more second connectors 108 of the one or more smart-devices 104 can allow the following: the AC carrying pins can allow electricity to pass from electrical carrying wire connected to the switchboard 102 electrically coupled to the one or more smart-devices 104 for controlling, and/or utilizing the electrical energy for one or more smart-devices 104 and/or to supply them to other loads connected to the one or more smart-devices 104. The DC carrying pins can allow the communication between the switchboard 102 and the one or more smart-devices 104 in form of data such as commands, polling, status, programmatic-events, instructions, and similar functions to control the state and function performed by either switchboard 104 and the one or more smart-devices 102.

These DC carrying pins can also carry DC power that can allow one or more smart-devices 104 to utilize this DC power to power-up and/or function and/or for added features such as connecting the USB that may extract power from DC carrying pins to power-up other USB powered loads and the like. The one or more smart-devices 104 have the option to extract energy either from the DC carrying pin source and/or from the AC carrying pin source that can be predetermined and/or post-determined using hardware architecture or can be controlled using the built-in software/firmware of the apparatus 100.

In another embodiment, the one or more smart-devices 104 and the switchboard 102 may include electrical/electronic circuits such as resistors, processors, actuators, capacitors, wireless communicators, current sensing circuits and the like on the PCB that work with various wireless technologies. The receiver in the switchboard 102 and/or in the one or more smart-devices 104 of the electrical apparatus 100 may receive input signals pertaining to parameters of power and/or other inbuilt-function from user through the wireless technologies such as Bluetooth, WiFi, cellular internet, Zigbee, Zwave and other such protocols, to operate the regulator to supply power to the corresponding first connector 106 according to the received parameters to control the supply of electrical energy in form of AC or DC power to the appliances, and the one or more smart-devices 104 can be controlled via wireless devices through wireless communications and/or through manual in-built push buttons. Thus, the apparatus 100 can be controlled programmatically using wireless communications, and can be controlled manually.

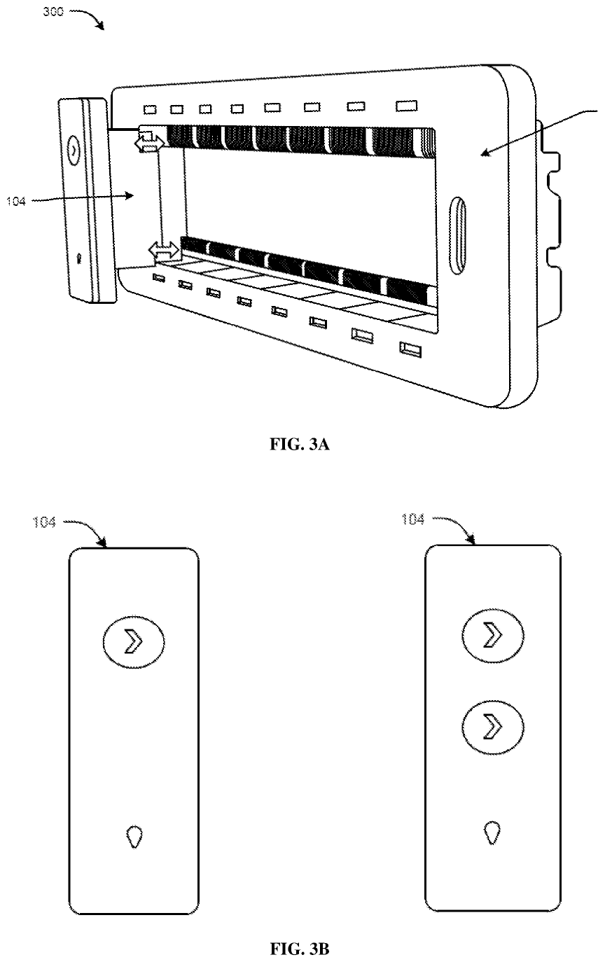

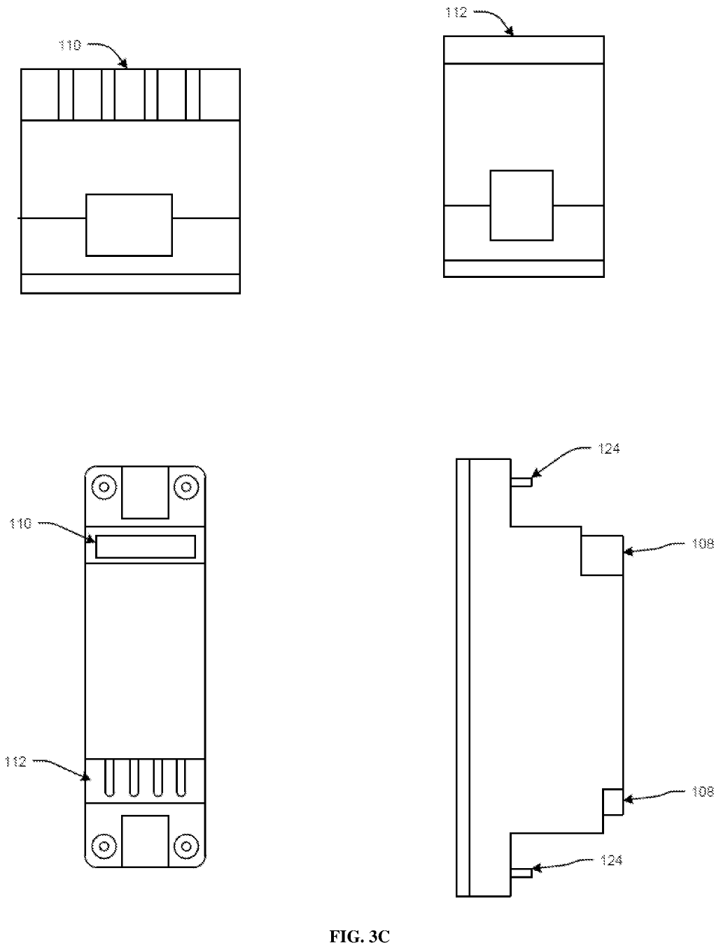

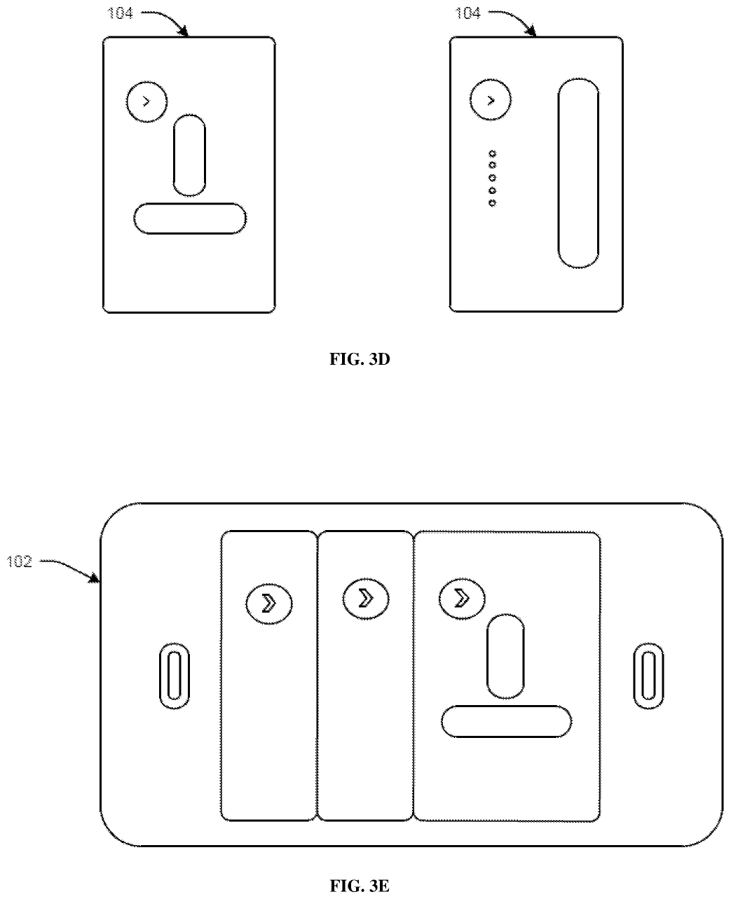

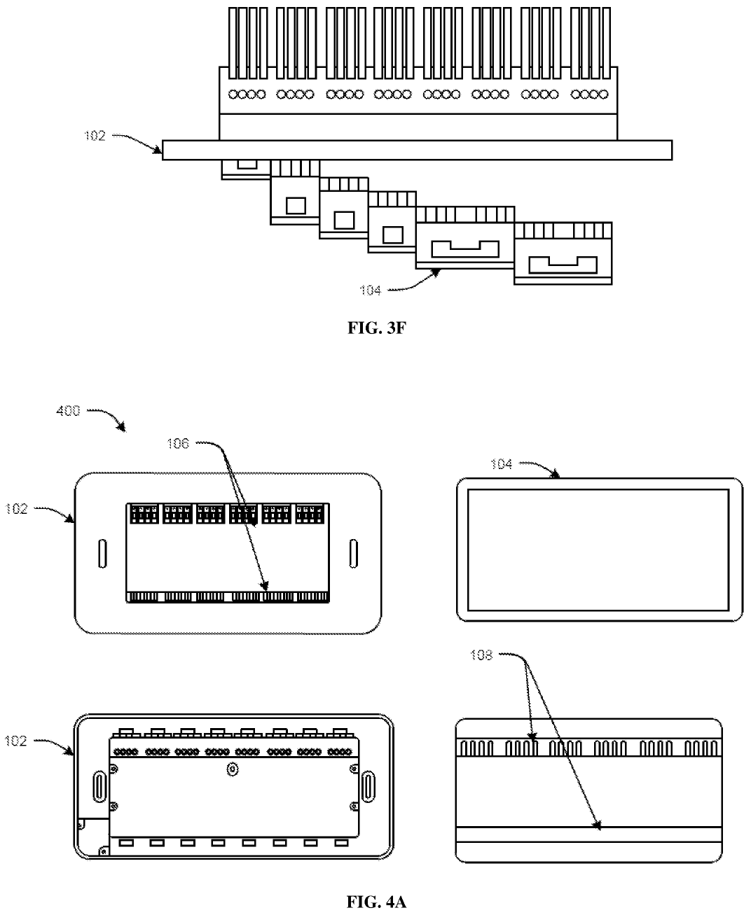

In another embodiment, the frontal design of a-socket-type-smart-device can be based on universal socket design but the differentiating factor is that no round holes or the plug holes can be visible, this can make the socket-type-smart-device look more aesthetically appealing while being functionally the same as the universal socket designs as depicted in the FIG. 3D. The switchboard 102 may consist of a cover plate 126 as illustrated in FIG. 1E that snap-fits on the front of the switchboard 102 irrespective of whether the one or more smart-devices 104 are inserted or not. This cover plate 126 can be used to change the aesthetic appeal of the switchboard 102. There can be no change in the function of the switchboard 102 or the one or more smart-devices 104 whether the cover plate 126 is added or removed. Standard screws 128 can be covered by screw cap 130 to improve the aesthetics of the apparatus 100.

FIGS. 2A-2D illustrate exemplary representation of one or more first connectors mounted on top portion of switchboard, in accordance with an embodiment of the present disclosure.

Referring to FIG. 2A, one or more first connectors 106 mounted on top portion 200 of switchboard 102 can be configured to connect the existing electrical wiring 204 with the switchboard 102. The top portion 200 of switchboard 102 may include many of the same components introduced in FIG. 1A to FIG. 1B above. Those components that are unchanged in this embodiment retain their original element number and are not reintroduced. The electrical wiring 204 can be capable of supplying electric energy to appliances and/or the miniature circuit breaker (MCB) box using at least one or combination of the phase/live, neutral and/or earth electrical wires. The electrical junction box/electrical flush box that houses at least one wiring for the electrical appliance in the apparatus 100. It can be the cavity in the wall through which the electrical wires 204 relate to one or more smart-devices 104 such as electrical switches, sockets, dimmers allowing users to control the supply of electricity to the electrical appliances.

In an implementation, the one or more first connectors 106 mounted on the switchboard 102 can connect the existing electrical wiring 204 with the switchboard 102 using standard screws 206 as illustrated in FIG. 2B, to keep the electrical wires 204 intact in their place. The main supply of the electricity can be turned off using the MCB, and/or main switch and/or circuit breaker to stop the flow of electricity in the apparatus 100. For example, in case of, existing traditional switchboards in the residential place, the wires need to be dissembled such that all the wires 204 are exposed, and in case, where existing traditional switchboards is not available, the wires can be exposed. The switchboards 102 with one or more first connectors 106 can accept connection from electrical wires 204 such as live wire and/or neutral wire and/or earth wire, these contacts 202 can be placed on the top-backside of the switchboards 102 and the total number of contacts may vary based on the size of the switchboards 102.

In another embodiment, the apparatus 100 of size 4 with one or more first connectors 106 on the top portion to connect the electrical wiring 204 as illustrated in FIG. 2C, at least one appliance output wire can be connected to one of the electrical contacts except the ones where live, neutral or earth electrical wires are already connected, and push the switchboard 102 into the electrical junction box/electrical flush box and mount it on the wall using screws 206, clips, nuts, bolts and the like. Depending upon the kind of load connected on the back of one or more first connectors 106 of the switchboard 102, the user can insert, plug, mount the desired one or more smart-devices 104 such as switch module, a double switch module and the like in order to turn them on/off or the user can use an electric dimmer module in order to control the supply of the electricity to the load.

The apparatus 100 of size 4 illustrated in FIG. 2D, connected with at least one electrical wiring 204 and one or more smart-devices 104 are about to be mounted inside the frontal cavity of the switchboard 102 of the apparatus 100. User can also insert, mount, clip, connect the choice of one or more smart-devices 104 in the frontal cavity of the switchboard 102, to allow the user to control the one or more load using the optional push button provided on the switch module or using the capacitive touch and/or switch provided on the dimmer module.

For example, user can connect more than one appliance connection by adding switch, double switch or dimmer module where the connection is made between the appliance output wire and the electrical contacts on the switchboard 102. If the user wants to use at least one socket in the switchboard 102, the user can simply insert, mount, clip connect the socket module anywhere on the frontal cavity of the switchboard 102 once the phase, neutral and earth electrical wiring is connected as per FIG. 2B. The user can control the supply of the electricity through the socket by using an optional in-built push button on the socket module or by sending commands/information via wireless communications to switchboard 100

In another embodiment, the user can mount or demount their existing smart-devices 104 from the switchboards 102 enabling users to upgrade and/or add and/or repair the one or more smart-devices 104 effectively. For example, if the user need to add a motion sensor to the switchboard 102, user can simply take out the existing smart-devices 104 and mount/insert the motion sensor based one or more smart-devices 104 that has motion detection capabilities, this implementation do not require any change in wiring, and they do not require frequent changes of one-time/portable/rechargeable batteries as the one or more smart-devices 104 get electrical energy in form of AC or DC from the switchboard 102 using the first and second connectors.

The switchboard 102 and the one or more smart-devices 104 can be built with various resettable and/or replaceable fuses as well as electrical current sensors that can allow the switchboard 102 to monitor the amount of electricity used by each and every appliance connected to the switchboard 102, which can then be used to limit/cut-off the AC and/or DC power in an unlikely event of over-current, voltage-surge, short-circuit or similar events in order to safeguard the user's appliances from the electrical damage and/or safeguard the switchboard 102 from unwanted electrical damages.

FIGS. 3A-3F illustrate exemplary view of the variable configuration of one or more smart-devices, in accordance with an embodiment of the present disclosure

Referring to FIG. 3A, the variable configuration 300 of clip-on one or more smart-devices 104 can be hot-swapped for adding/removing/upgrading new functionalities in the apparatus 100, the one or more smart-devices 104 may include smart switches, smart sockets, smart dimmers (fan and/or light), motion sensor, occupancy sensor, USB ports, speaker and/or microphone, infrared receiver and/or emitter, smart camera, combination of RBG LED night lights, display touch screen and the like. The apparatuses 100 embodied in this disclosure can be easier to upgrade as the user can hot-swap the one or more smart-devices 104 based on their individual desires and/or requirements, this can be done without having the user to rewire the apparatuses 100.

In an embodiment, the smart 10A electrical switch with a push buttons and dual smart 10A electrical switch with two push buttons as illustrated in FIG. 3B, can be adapted to turn on/off the supply of current to the connected load and having integrated LED or any suitable light source, which can change animation and colours based on the requirement of the user and in-built functions such as turning on/off an load or dimming the load connected to the apparatus 100. Internet configurable LED light animations and/or colours of the LED can be displayed on the one or more smart-devices 104 through the communication between switchboard 102 and one or more smart-devices 104. FIG. 3C illustrates the one or more smart-devices 104 with any suitable size having at least one electrical contact e.g., 4 electrical contacts at the top portion to control the supply of electric current flowing to the appliances, at least one electrical contact e.g., 8 electrical contacts at bottom portion to communicate/exchange information as well as low powered DC power supply with the switchboard 102, and one or more smart-devices 104 with size 1 as illustrated in FIG. 3C or any suitable size exposing any or a combination of male and female pins (110, 112).

In another embodiment, FIG. 3D illustrates the smart 16 A electrical socket of size 2 with electrical plug holes manufactured in a manner that looks more aesthetically pleasing while providing the same electrical functionality and the optional push button can be adapted to turn on/off the supply of current having integrated LED which can change animation and colours based on commands from user. Smart 10A electrical dimmer of size 2 with capacitive touch to control the supply of current having integrated LED which can change animation and colours based on commands and a push button to turn on/off the supply of current. The apparatus 100 with one or more smart-devices 104 clipped on in other specific combination, for example, more than 1500 combinations can be possible considering various smart-devices 104, the smart-devices 104 as illustrated in FIG. 3E include a combination of electrical 10A switch, and electrical 16A socket. The apparatus 100 as shown in FIG. 3F illustrates the at least one electrical wiring 204 connection and one or more smart-devices 104 are about to be mounted inside the frontal cavity of the apparatus 100.

In another embodiment, using the DC carrying pins and/or AC carrying pins on the one or more smart-devices 104 as well as on the switchboard 102, the switchboard 102 can detect exactly where the one or more smart-devices 104 can be inserted i.e. on which position or in which cavity on the switchboard 102. The DC carrying pins and/or AC carrying pins can determine what type of one or more smart-devices 104 it is, whether it is an AC powered module, and/or a DC powered module, whether it can be a socket, switch, dimmer or camera or any other smart-devices 104. It can also detect the digital signature of the one or more smart-devices 104 to understand whether it is a certified smart-devices 104 or not, which helps to keep the apparatus 100 and the user safe from the counterfeit, unauthorised replicas or unsafe smart-devices 104 which can result in breach of privacy or loss of control from the apparatus 100.

The apparatuses 100 may have inbuilt technologies such as long-term evolution (LTE), Wi-Fi, Bluetooth, other wireless communication protocols such as near field communication (NFC), proximity cards, integrated circuits, computational processors, various types of resistors, capacitors, push-buttons that can allow user to control the apparatus 100 through internet communication using controller app on computing device such as smartphone, mobile terminal, computer and the like, and can control the apparatus 100 through commanding voice assistants using their voice, and even with the push buttons and/or capacitive touch sliders to turn on/off and/or dimming electrical and/or electronic appliances.

For example, if user want to use the switchboard 102 through internet technologies to manage the electronic appliances, the user can register the apparatus with online system servers of switchboards 102, by downloading controller executable instructions from the play store and/or app store and/or from website. Register an account using mobile number and/or email address of user and the like, click on scan quick response (QR)code and point the camera of the smartphone or the desktop and the like on the frontal cavity of the installed switchboard 102 or on the packaging box where the user can see unique QR code of the installed switchboard 102, alternatively user can input the device id and the password in the controller executable instructions which are printed on switchboard 102 or on the packaging box

The switchboard 102 and the one or more smart-devices 104 can work with WiFi Routers or WiFi hotspot that can allow the apparatus 100 to connect to the cloud services through internet telephony. The user can input his/her credentials as well as the credentials of the apparatus 100 in software application/controller executable instructions which then registers the user and/or the apparatus 102 with unique user identification. Once the user mounts at least one smart-devices 104, the apparatus 100 can sense and register the smart-devices 104 automatically and/or it can be registered manually by the user by pressing the push switch button on the module for a predefined number of seconds. The one or more smart-devices 104 can appear in the smartphone or voice assistant or desktop/laptop application that the user has registered with, and user can control the appliance using the internet as well as manually using the built-in switch on the smart-devices 104.

The smart-devices 104 have the necessary technology and electrical and/or electronic components built-in that can record the electrical energy usage data e.g., estimate energy consumption of one or more loads/individual appliance to which the one or more smart-devices 104 can be connected through one or more first connectors 106. This is achieved through an integrated-circuit that can record current usage when the device is turned on and share the data with the user via various methods such as email, notification, message through digital telecommunications channels based on but not limited to internet, Bluetooth, other wireless communication protocols such as NFC, proximity cards, wi-fi and the like

In another embodiment, the switchboard 102 can be operated offline as well as online using learning engine, the processor 114 can be operatively coupled to the learning engine 118 which can detect the behavioural patterns of using the electrical appliances and can automatically suggest user to create schedule/timetable/time-breaker/scenes that can automatically control the electrical appliances based on the context detected by the learning engine 118, the electrical appliances can also be controlled individually based on the data received from various internet servers. The apparatus 100 can collect exhaustive weather data from various internet servers and/or data from mountable/de-mountable smart-sensors allowing users to manage the supply of the electricity whether it is AC and/or DC to their electrical and/or electronic devices, for example, weather data can be extracted from various internet servers and can be received by the switchboard 102, the switchboard 102 can process the weather data to control the electrical and/or electronic devices based on the requirement of the user.

In another embodiment, the learning engine 118 can be trained using the historical data of correlation received from the one or more smart-devices 104 to determine the behavioural patterns of the individual/user usage of the one or more loads associated with the one or more smart-devices 104. The one or more smart-devices 104 can provide the historical data report of the associated one or more loads to the switchboard 102, the learning engine 118 in the switchboard 102 can extract the historical data report from the one or more smart-devices 104 to determine the behavioural patterns of the one or more loads utilized by the user, for example, routine usage of the electrical/electronic appliances by the user is determined.

For example, if the user sleeps every day at 11 pm and the user turn the lights off by 10:45 pm, the apparatus 100 can learn and suggest the user to make it execute the same operation everyday, automatically. If the user confirms the request then the lights can automatically turn off at 10:45 pm everyday. User always have authority to modify/cancel/override these schedules/timetable/time-breaker/scenes from the mobile app/desktop app/website whenever he/she deems fit.

In another embodiment, users can manually create schedules/timetable/time-breaker/scenes that can automatically control the electrical appliances based on the context detected by the learning engine 118. The context can be any of the following but not limited to arrival or departure or when motion or an object is detected and/or absent, change in temperature, change in humidity, change in wind speed, change in precipitation, change in atmospheric pressure, change in weather, time of the 24-hour day period. These contexts can take place either inside and/or outside the commercial and/or residential property.

In another embodiment, the apparatus 100 can be controlled programmatically using internet technologies such as but not limited through smartphone mobile app, website, voice assistant, desktop application. The apparatuses 100 can be controlled manually by the user, using buttons such as but not limited to push-button, knob, an on/off switch and any combination thereof. The apparatus 100 and/or one or more smart-devices can use low voltage direct current to provide instruction to the regulator to control the supply of electricity to turn on/off and/or dim the appliances, which can drastically reduce the likelihood of getting electrical shocks due to switch bouncing phenomenon.

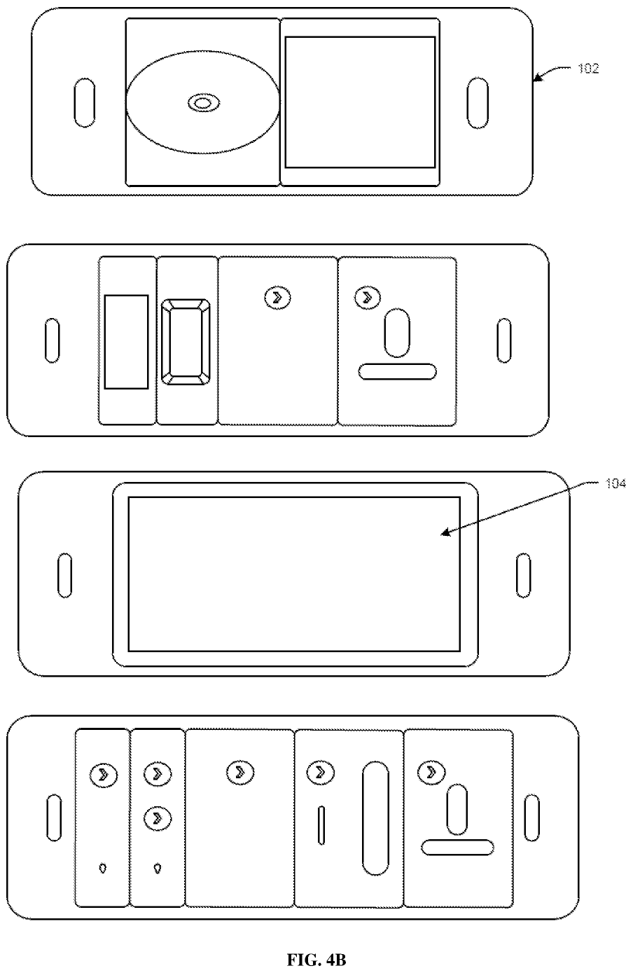

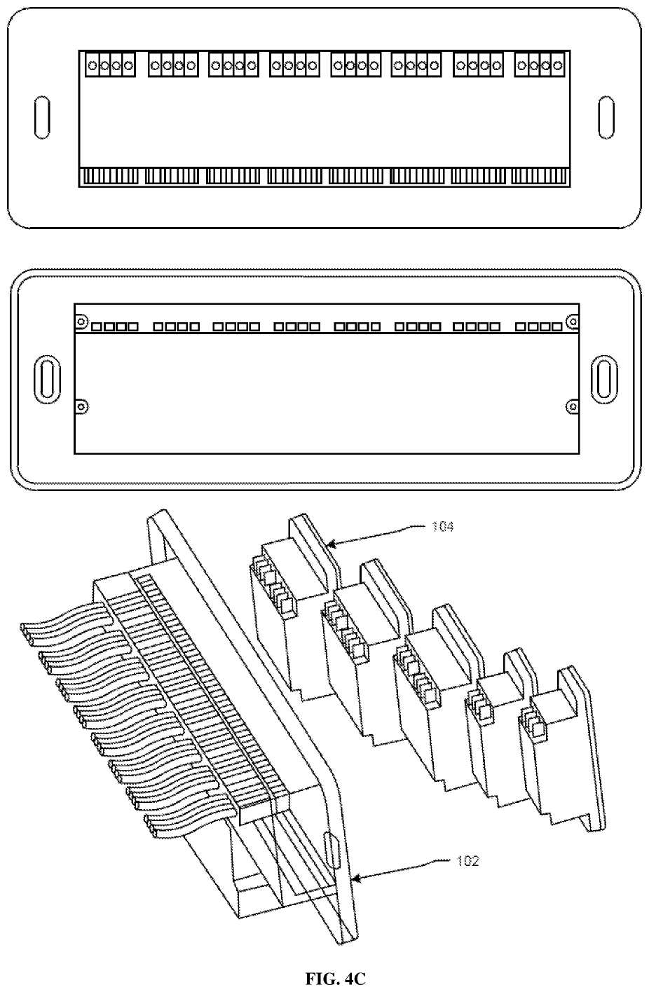

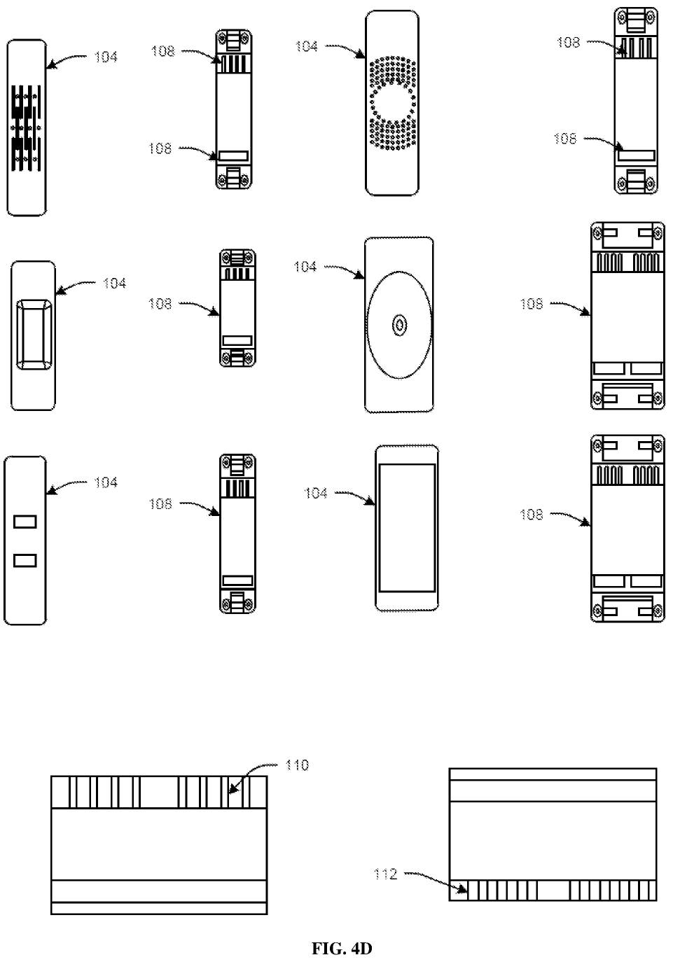

FIGS. 4A-4D illustrate exemplary view of apparatus of variable size, in accordance with an embodiment of the present disclosure.

In an embodiment, the apparatus 100 of variable size 400 can be illustrated in FIG. 4A, the switchboard 102 can be made in variable sizes based on the number of cavities required such as 1,2,3,4,5,6,7,8, to n. These cavities can be arranged in any or a combination of rectangular, square, and circular shapes and installed in the wall. The size of the one or more smart-devices 104 and the switchboard 102 can vary based on the requirement of the users. For example, smart-devices 104 can be pluggable, they can be non-electrical items, various sizes such as smart-devices 104 that has a large touch screen and covers all the frontal cavity spaces on the switchboard 102 as illustrated in FIG. 4A, and the size of each one or more smart-devices 104 can be as small as one cavity position, to all the cavity space available in the switchboard 102.

The apparatus 100 in size 6 as shown in FIG. 4A with front cavity having one or more first connectors 106 for controlling the supply of electricity and to exchange information/data/commands/status/actions as well as supply DC power, without mounting one or more smart-devices 104, and the apparatus 100 in size-8 with the one or more first connectors 106 to connect the electrical wiring 204 are illustrated in FIG. 4A. The apparatus 100 in size-6 or any suitable size with one or more smart-devices 104 clipped on in a specific combination as illustrated in FIG. 4B, the apparatus 100 can have more than 50,000 combinations, the one or more smart-devices 104 can include electrical 10A switch, electrical 10A switch, 2× electrical 10A switch, electrical 16A socket, and electrical 10A dimmer for electrical appliances.

The apparatus 100 in variable sizes, for example, size-4, size-6 and size-8 as illustrated in FIG. 4B can be coupled with one or more smart-devices 104. For example, the apparatus 100 with size-4 may include smart camera, smart speaker with mic, smart smoke sensor and the like mounted inside the switchboard 102, the apparatus 100 with size 4 can have minimum of 5000 different permutations and at least 200 different combinations. The apparatus 100 with size-6 may include smart IR receiver and sender, smart motion sensor, smart high-powered switch 30A, smart socket 16A, smart touch display screen and the like mounted inside the switchboard 102, the apparatus 100 with size 6 can have minimum of 1,50,000 different permutations and at least 200 different combinations. The apparatus 100 with size-8 may include one smart 10A switch, smart dual 10A switch, high powered switch smart 10A dimmer and smart socket 16A and the like mounted inside the switchboard 102, the apparatus with size-8 can have minimum of 18,14,400 different permutations and at least 45 different combinations.

The apparatus 100 in size −8 with front cavity having one or more first connectors 106 having any or a combination of male pins 110 and female pins 112 shown in FIG. 4C for controlling the supply of electricity and to exchange data, with one or more first connectors 106 to connect the electrical wiring 204 and the one or more smart-devices 104 are about to be mounted inside the frontal cavity of the apparatus 100. Different types of one or more smart-devices 104 can be illustrated in FIG. 4D, smart motion sensor, smart temperature detector, smart dual USB with internal circuit, smart smoke detector, smart camera module, smart speaker with in-built mic and the like, the one or more smart-devices 104 can include push buttons to turn on/off the supply of current to the connected load having integrated LED which can change animation and colours based on commands, the back view illustrated in FIG. 4D of one or more smart-devices 104 may include any or a combination of male pins 110 and female pins 112 to carry AC power, DC power and data. The combination of male pins 110 and the female pins 112 may include for example, 8 electrical contacts at the top portion to control the supply of electric current flowing to the appliance and 16 electrical contacts at the bottom portion to communicate/exchange information with the switchboard 102 effectively.

The one or more smart-devices 104 can exchange information in form of data, commands, status, or any transfer of bits/bytes to/from switchboards 102 using the male pins 110 and female pins 112 through which one or more smart-devices 104 and switchboards 102 connect. The one or more smart-devices 104 get electrical energy either in form of AC or DC energy from electrical wiring and/or apparatus 100 to either utilize in real time and/or to store in their individual smart-devices circuits from switchboards 102 using the male and female pins (110, 112) through which smart-devices 104 and switchboards 102 connect.

It will be apparent to those skilled in the art that the electrical control apparatus 100 of the disclosure may be provided using some or all the mentioned features and components without departing from the scope of the present disclosure. While various embodiments of the present disclosure have been illustrated and described herein, it will be clear that the disclosure is not limited to these embodiments only. Numerous modifications, changes, variations, substitutions, and equivalents will be apparent to those skilled in the art, without departing from the spirit and scope of the disclosure, as described in the claims.

### Advantages of the Present Disclosure

The present disclosure provides an apparatus that can be upgraded easily as the user can hot-swap the one or more smart-devices based on their individual desires and/or requirements, without re-wiring the complete electrical apparatuses.

The present disclosure provides an apparatus that can be controlled programmatically using wireless communications, and/or can be controlled manually using in-built switch.

The present disclosure provides an apparatus that can record the electrical energy usage data of an individual and/or group of appliances connected to the one or more smart-devices.

The present disclosure provides an apparatus and/or smart-devices that can use low voltage direct current to control the supply of electricity to turn on/off and/or dim the appliances, which can drastically reduce the likelihood of getting electrical shocks caused due to switch bouncing phenomenon.

The present disclosure provides an apparatus that can allow the users to pre-schedule and/or create countdown and/or create timetable for the electrical and/or electronic appliances connected to the electrical apparatus, to control the supply of electricity to other electric and/or electronic appliances based on the requirement of the user.

The present disclosure provides an apparatus that can detect the heat and/or movement of objects in the environment to allow user to pre-program and/or schedule and/or to real-time control the supply of electricity to the electrical and/or electronic devices connected to the electrical apparatus.

The present disclosure provides an apparatus that can be repaired and/or upgraded easily and can be cost-effective.

The present disclosure provides an apparatus that can safeguard the user's appliances from the electrical damage and/or safeguard the switchboard from unwanted electrical damages.

We claim:

1. An apparatus (100) for distributing supply of power to one or more loads, characterized in that the apparatus comprising:
a switchboard (102) comprising one or more first connectors (106), the one or more first connectors configured to supply power to corresponding one or more loads, the one or more first connectors configured to receive an input power supply;
one or more smart-devices(104) associated with corresponding one or more loads, the one or more smart-devices configured to electrically couple with corresponding one or more first connectors, the one or more smart-devices configured to receive a power supply from a power source, each of the one or more smart-devices comprising:
a regulator to control the supply power to a corresponding coupled one or more first connector;
a receiver configured to receive input signals pertaining to parameters of power to be supplied to an associated load of the one or more loads, the parameters pertaining to any or a combination of voltage, frequency, time and pulse width modulation of the power; and
a processor (114) operatively coupled with the switchboard and the one or more smart-devices, the processor (114) operatively coupled with a memory (116), the memory storing instructions executable by the processor to:
receive, the input signals pertaining to parameters of power to be supplied to the associated load; and
operate the regulator to control the supply power to the corresponding coupled one or more first connector according to the received parameters,
wherein the power supplied to the corresponding coupled one or more first connector is transmitted to the associated load to operate the associated load.

2. The apparatus as claimed in claim 1, wherein the one or more smart-devices associated with a combination of zero loads.

3. The apparatus as claimed in claim 1, wherein the one or more smart-devices can include switch, light dimmer, fan regulator, microphone, speaker, camera, infrared emitter, infrared receiver, motion detector, thermal detectors and any combination thereof, wherein the one or more smart-devices(104) and the switchboard (102) are of variable size and shapes.

4. The apparatus as claimed in claim 1, wherein the one or more smart-devices(104) comprises one or more second connectors (108) configured to electrically couple with corresponding one or more first connectors (106), the first connectors and the second connectors comprises any or a combination of male pins (110) and female pins (112) to carry any or a combination of alternating current (AC) power, direct current (DC) power and data between the one or more smart-devices (104) and the switchboard (102).

5. The apparatus as claimed in claim 1, wherein the communication between the switchboard (102) and the one or more smart-devices (104) is performed by any or a combination of wired mode, wireless communication mode and coupled connectors.

6. The apparatus as claimed in claim 1, wherein the one or more smart-devices (104) is configured to store and supply power received from the switchboard (102), the power received is any or a combination of AC and DC.

7. The apparatus as claimed in claim 1, wherein one or more light emitting diodes (LEDs) is configured in the one or more smart-devices, the one or more LEDs adapted to change colours based on any or a combination of in build functions and information received from user.

8. The apparatus as claimed in claim 1, wherein the processor (114) is operatively coupled to a learning engine (118), the learning engine is trained using a historical data of correlation received from the one or more smart-devices (104), wherein the switchboard (102) determine behavioural patterns of the corresponding one or more loads associated with the one or more smart-devices (104).

9. The apparatus as claimed in claim 1, wherein the one or more smart-devices (104) is replaceable with another one or more smart-devices having any or a combination of similar and different functions in the switchboard without rewiring.

10. The apparatus as claimed in claim 1, wherein the switchboard (102) is configured to detect any or a combination of the position of the one or more smart-devices, digital signature and type of one or more one or more smart-devices.

11. The apparatus as claimed in claim 1, wherein the one or more smart-devices(104) is configured to record the current usage of the corresponding one or more loads connected to the one or more smart-devices through one or more first connectors.
